(19) United States
(12) Patent Application Publication
(10) Pub. No.: US 2015/0050463 A1
(43) Pub. Date: Feb. 19, 2015

(54) RAPID PROTOTYPING MODEL, POWDER RAPID PROTOTYPING APPARATUS AND POWDER RAPID PROTOTYPING METHOD

(71) Applicant: Aspect Inc., Tokyo (JP)

(72) Inventors: Shizuka NAKANO, Tsukuba-shi (JP); Toru SHIMIZU, Tsukuba-shi (JP); Masashi HAGIWARA, Inagi-shi (JP); Masahiro SASSA, Ichinomiya-shi (JP)

(73) Assignee: Aspect Inc., Tokyo (JP)

(21) Appl. No.: 14/265,794

(22) Filed: Apr. 30, 2014

(30) Foreign Application Priority Data
Aug. 19, 2013 (JP) 2013-169855

(51) Int. Cl. B28B 17/00; B23K 26/34; B23K 26/00; B28B 1/00; B22F 3/105

(52) U.S. Cl. CPC B28B 17/0081; B28B 17/0063; B28B 1/001; B22F 3/1055; B23K 26/0081; B23K 26/345; B22F 2003/1056; B33Y 80/00; B33Y 10/00; B33Y 30/00
USPC 428/192; 425/162; 264/497; 219/76.14; 219/72

(57) ABSTRACT

A powder rapid prototyping method includes steps of forming a thin layer 35a of a powder material, irradiating a heating energy beam to a specific region of the thin layer 35a of the powder material to thereby form a preliminary heating layer 35c whose temperature is elevated, and irradiating the heating energy beam to an inside region of the preliminary heating layer 35c whose temperature is elevated to melt and then solidify the thin layer 35a of the powder material to thereby form a solidified layer, wherein the respective steps are repeatedly implemented to fabricate a rapid prototyping model 51, 52.

### CROSS-REFERENCE TO RELATED APPLICATION

This application is based on and claims priority of Japanese Patent Application No. 2013-169855 filed on Aug. 19, 2013, the entire contents of which are incorporated herein by reference.

### FIELD

The present invention relates to a rapid prototyping model, a powder rapid prototyping apparatus and a powder rapid prototyping method, and more particularly to the powder rapid prototyping apparatus and the powder rapid prototyping method, which are adapted to fabricate a three-dimensional prototyping model through selectively irradiating energy beam like laser beam or particle beam, etc. such as electron beam to a thin layer of powder material made of metal or ceramic to thereby melt and solidify the thin layer and subsequently laminating such solidified layers, and a rapid prototyping model fabricated by the powder rapid prototyping apparatus and the powder rapid prototyping method.

### BACKGROUND

In recent years, in order to fabricate a substitute for a metallic product, a prototyping model of a product placed in a high-temperature environment or used in. an application such that higher strength is required, or a high variety low volume mass-production component, etc., there have been researched and developed powder rapid prototyping apparatus and powder rapid prototyping methods adapted for irradiating energy beam to metallic powder etc. to melt and solidify, and thereby fabricating a rapid prototyping model.

According to a powder rapid prototyping method of the patent document 1 (Japanese Patent Laid-open Hei. 08-281807), a base formed by solidifying powder material is first mounted on. the entire surface of an elevating board to support object. In that state, a powder layer to be the first layer is solidified or sintered on the base to rigidly stick the first layer of a prototyping model together to the base. Further, a second layer or more to be the prototyping model is then laminated thereon. Thus, warp or distortion of a completed prototyping model is suppressed. In this case, after a prototyping process is completed, the prototyping model is cut and thus separated from the base by using metal-sawing tool.

In a patent document 2 (Japanese Patent Laid-open No. 2010-100884 publication), a plurality of pins spaced apart from each other are mounted on a prototyping table in place of the base (prototyping plate) of the patent document 1 to fabricate a three-dimensional prototyping model thereon.

However, in the technologies described in the above-described patent documents 1 and 2, it is necessary to prepare the base or the pins.

Moreover, in both the patent documents 1 and 2, in order to suppress deformation of the prototyping model, the prototyping model is fixed to the base or the pins. For this reason, after the prototyping process is completed, it is necessary to remove the base or the pins from the prototyping model by cutting, etc.

In addition, in both the patent documents 1 and 2, since the base or the pins cannot be mounted in the middle of lamination, it is impossible to start fabricating another different rapid prototyping model within an empty region around the prototyping model in the middle of lamination.

### SUMMARY

The present invention contemplates to provide a powder rapid prototyping apparatus and a powder rapid prototyping method which can efficiently fabricate a rapid prototyping model while suppressing deformation of the rapid prototyping model, and a rapid prototyping model fabricated by the apparatus and the method.

According to one aspect of the present invention, there is provided a powder rapid prototyping apparatus including: an elevating table on which a thin layer of a powder material is formed; heating energy beam outputting means which output heating energy beam for heating the thin layer of the powder material; and a control section which controls prototyping process, wherein the control section controls the elevating table to form a thin layer of the powder material on the elevating table, controls the heating energy beam outputting means to irradiate the heating energy beam to a specific region of the thin layer of the powder material to thereby form a preliminary heating layer whose temperature is elevated, and controls the heating energy beam, outputting means to irradiate the heating energy beam to an inside region of the preliminary heating layer whose temperature is elevated to melt and then solidify the thin layer to thereby form a solidified layer.

According to another aspect of the present invention, there is provided a powder rapid prototyping method including steps of: forming a thin layer of a powder material; irradiating a heating energy beam to a specific region of the thin layer of the powder material to thereby form a preliminary heating layer whose temperature is elevated; and irradiating the heating energy beam to an inside region of the preliminary heating layer whose temperature is elevated to melt and then solidify the thin layer to thereby form a solidified layer, wherein the respective steps are repeatedly implemented to fabricate a rapid prototyping model.

According to still another aspect of the present invention, there is provided a rapid prototyping model in which a periphery of a solidified prototyping model is covered by a portion of a preliminary heating layer.

The object and advantages of the invention will be realized and attained by means of the elements and combinations particularly pointed out in the claims.

It is to be understood that both the foregoing general description and the following detailed description are exemplary and explanatory and are not respective of the invention, as claimed.

### BRIEF DESCRIPTION OF THE DRAWINGS

FIG. 1 is a view illustrating the constitution of a powder rapid prototyping apparatus according to an embodiment of the present invention.

FIG. 2 is a diagram illustrating a laser beam outputting section of the powder rapid prototyping apparatus according to the embodiment of the present invention.

FIG. 3A is a top plan view illustrating the constitution of a thin layer forming section of the powder rapid prototyping apparatus according to the embodiment of the present invention, and FIG. 3B is a diagram illustrating the cross section taken, along I-I line of FIG. 3A and a laser light outputting section disposed above the thin layer forming-section.

FIGS. 4A to 4I are cross sectional views illustrating a powder rapid prototyping method according to the embodiment of the present invention.

FIG. 5 is a diagram illustrating the constitution of a powder rapid prototyping apparatus according to the first modified example of the embodiment.

FIGS. 6A and 6B are cross sectional diagrams illustrating a powder rapid prototyping method according to the second modified example of the embodiment.

FIG. 7A is a cross sectional view illustrating a powder rapid prototyping method according to the third modified example of the embodiment, and FIG. 7B is a cross sectional view illustrating a powder rapid prototyping method according to the fourth modified example of the embodiment.

### DESCRIPTION OF EMBODIMENTS

Hereinafter, embodiments of the present invention will now be described with reference to the drawings.

(1) Constitution of the Powder Rapid Prototyping Apparatus

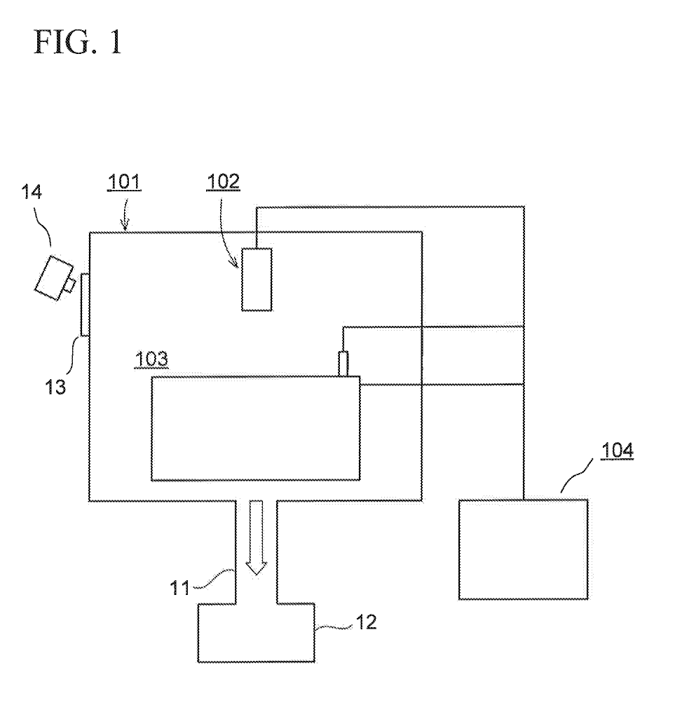

FIG. 1 is a view illustrating the constitution of the powder rapid prototyping apparatus according to an embodiment of the present invention.

It is to be noted that there are a laser beam source for emitting laser beam, an electron beam source for emitting electron beam, and other particle beam source for emitting other particle beam as heating energy beam sources adapted to emit heating energy beam for implementing prototyping process, and those heating energy beam sources are applicable to the present invention. In this mbodiment described below, the laser beam source is used.

This powder rapid prototyping apparatus includes a decompressible chamber (decompression vessel) 101, a laser beam outputting section 102 and a thin layer forming section 103 which are installed in the chamber 101, a control section 104 provided outside the chamber 101, and an infrared ray temperature detector 14. The decompressible chamber 101 includes an exhausting port 11 to which an exhausting device 12 is connected. Thin layers of powder material are formed in the thin layer forming section 103. The infrared ray temperature detector 14 detects a surface temperature of a powder material, etc, subject to heat treatment at the thin layer forming section 103. The surface temperature detection is performed through a light transmission window 13 for infrared ray, which is provided at a partition wall of the chamber 101. It is to be noted that the laser beam outputting section 102 may be provided outside the chamber 101. And in that case, a light transmission window for laser beam may be provided at a partition wall of the chamber 101.

The control section 104 of this powder rapid prototyping apparatus performs a control to form a thin layer of the powder material, and to sinter or melt and then solidify the thin layer to thus form a prototyping model.

It is to be noted that the above-described action of “sintering, or melting and then solidifying” will be collectively expressed hereinafter as a “solidifying” action in order to avoid redundant expression. In case of necessity, a particular action of the actions will be explicitly specified in a distinguished manner.

Details of respective sections in this powder rapid prototyping apparatus will now be described below.

(i) Constitution of the Laser Beam Outputting Section 102

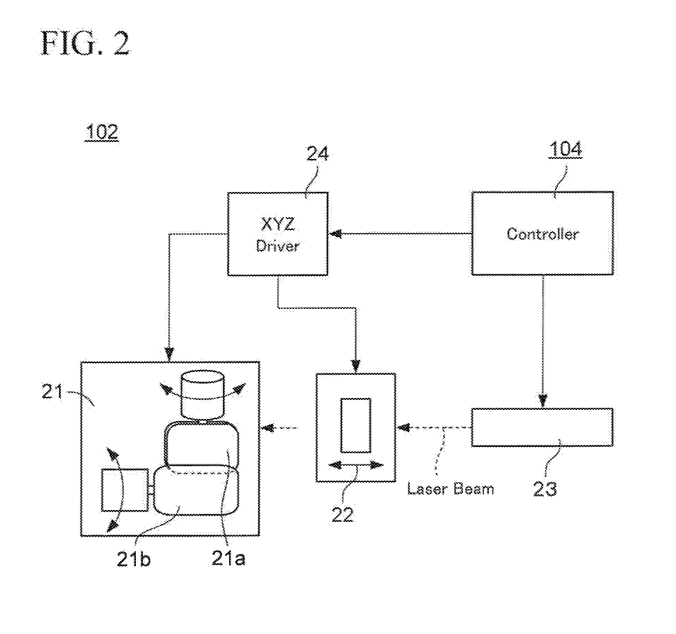

FIG. 2 is a view illustrating the constitution, of the laser beam outputting section 102 of the powder rapid prototyping apparatus according to the embodiment of the present invention.

The laser beam outputting section 102 includes a laser beam source 23, optical systems 21 and 22, and an XYZ driver 24.

As the laser beam source 23, there may be used a YAG laser beam source, or a fiber laser beam source, etc. which is adapted to emit a laser beam mainly having a wavelength of about 1,000 nm. In this case, however, a wavelength used may be changed as occasion demands by taking, into consideration, not only wavelength absorptance of the powder material but also cost performance, etc. For example, there may be used a high output CO₂ laser beam source which can emit a laser beam having a wavelength of about 10,000 nm.

The optical system 21 includes galvanometer mirrors (X-mirror, Y-mirror) 21a, 21b and the optical system 22 includes a lens. The X-mirror 21a and the Y-mirror 21b serve to respectively change outgoing angles of respective rays of the laser beam, to scan the laser beam in the X-direction and in the Y-direction. Moreover, the lens moves in accordance with movement of the laser beam scanned in the X-direction and in the Y-direction to match a focal length of the laser beam with the surface of the thin layer of the powder material.

The XYZ driver 24, in accordance with a control signal from the control section 104, sends out a control signal for operating the X-mirror 21a, the Y-mirror 21b and the lens.

It is to be noted that in the case where any other energy beam source is used in place of the laser beam as the heating energy beam source, the optical system may be changed as occasion demands in dependency upon the energy beam source. For example, in the case of the electron beam source, an electromagnetic lens and a deflection system may be used.

(ii) Constitution of the Thin Layer Forming Section 103

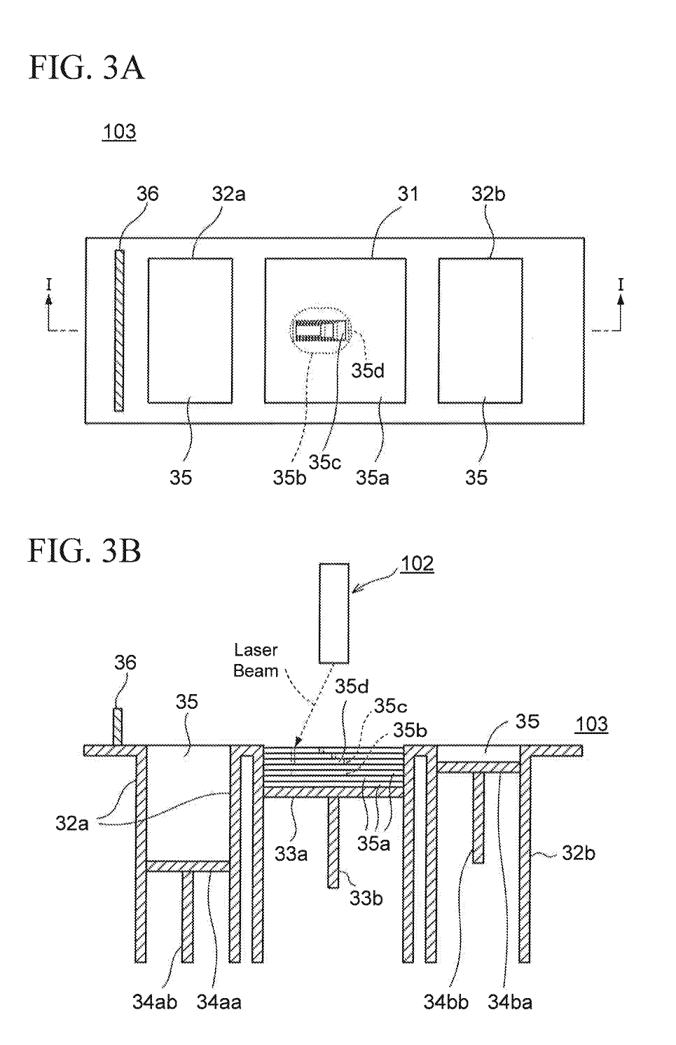

FIG. 3A is a top plan view illustrating the constitution of the thin layer forming section 103. FIG. 3B is a cross sectional diagram taken along the I-I line of FIG. 3A, and the laser beam outputting section 102 disposed above the thin layer forming section 101 is also illustrated in addition thereto in the drawings. In FIGS. 3A and 3B, illustration of the chamber is omitted.

The thin layer forming section 103 includes, as illustrated in FIGS. 3A and 3B, a thin layer forming container 31 within which prototyping process is implemented by irradiation of a laser beam, and first and second powder material containers 32a, 32b disposed on the both sides thereof. In order to prevent oxidation or nitrization of the powder material, the thin layer forming section 103 is installed within the decompressible chamber 101.

Further, the thin layer forming section 103 includes heater or any other heating means such as heating light source which are not illustrated in order to heat the powder materials accommodated within the respective containers 31, 32a and 32b, and the thin layer within the container 31. The heating means may be built in the respective containers 31, 32a and 32b, or may be provided around the respective containers 31, 32a and 32b.

In the thin layer forming container 31, a thin layer 35a of the powder material is formed on a part table (second elevating table, elevating table) 33a. Then, the thin layer 35a of the powder material is heated by irradiation of laser beam so that a base heating layer 35b, a preliminary heating layer 35c and a solidified layer 35d are formed. Next, the part table 33a is moved downward sequentially to laminate such solidified layer 35d. In this way, a three-dimensional prototyping model is fabricated.

In the first and second powder material containers 32a, 32b, powder material 35 is accommodated on the first and second feed tables (first and third elevating tables) 34aa and 34ba. In the case where either one of the first and second powder material containers 32a, 32b is caused to be a feed side, the other powder material container is caused to be the side to accommodate the powder material left after the thin layer of the powder material is formed.

Supporting shafts 33b, 34ab and 34bb are respectively attached to the part table 33a, and the first and second feed tables 34aa and 34ba. These supporting shafts 33b, 34ab and 34bb are connected to a driver (not illustrated) which is adapted to move the supporting shafts 33b, 34ab and 34bb in upper and lower directions.

The driver is controlled, by a control signal from the control section 104. The first or second feed table 34aa or 34ba on the feed side of the powder material is elevated to feed, powder material 35, and the second or first feed table 34ba or 34aa on the accommodating side is lowered to accommodate the power material 35 left after the thin layer is formed.

Further, there is equipped a recoater 36 movable over the entire region on the upper surfaces of the thin layer forming container 31 and the first and second powder material containers 32a, 32b. The powder material is projected onto the upper surface of the powder material containers 32a, 32b by elevation of the first or second feed table 34aa or 34ba on the feed side of the powder material. The recoater 36 serves to scrape the powder material thus projected while smoothening the surface thereof, and then carry the powder material thus scraped, up to the thin layer forming region. The recoater 36 serves to accommodate the powder material thus carried onto the part table 33a while smoothening the surface thereof to form the thin layer 35a of the powder material. The thickness of the thin layer 35a of the powder material is determined by a lowering amount of the part table 33a. Further, the powder material left after formation of the thin layer of the powder material is carried up to the powder material container 32b or 32a of the accommodating side to accommodate the powder material thus carried onto the second or first feed table 34ba or 34aa.

The movement of such a recoater 36 is controlled by a control signal from the control section 104.

(Powder Material)

As a usable powder material 35, there are enumerated metallic powder material or ceramic powder material, etc.

As the metallic powder material, there are enumerated aluminum (Al) (melting point of 660° C.), aluminum alloy, and a mixture in which at least either one of aluminum and aluminum alloy and any other metal are mixed, etc.

As the aluminum alloy, there may be enumerated an aluminum alloy in which at least one kind of Si, Mg, Co, Mn and Zn, for example, is contained in aluminum (Al). Moreover, as the mixture in which at least either one of aluminum and aluminum alloy is mixed with any other metal, there is enumerated a mixture in which at least one kind of substance selected from a group consisting of Mg, Cu, Ni, Cu₃P and CuSn is mixed into at least either one of aluminum (Al) and aluminum alloy with a suitable ratio, wherein Mg is used for utilizing reduction action, and Ni is used for improvement of wettability.

While mean particle diameter of the powder material is not particularly limited, it is sufficient to employ a size such as being capable of maintaining fluidity. This is because if not so, aggregation property of powder becomes stronger so that it would become difficult to form a thinner layer of the powder material.

As the metallic powder material, in addition to aluminum or aluminum alloy, there may be used metallic powder of titanium (melting point of 1668° C.), 64 titanium (melting point of 1540 to 1650° C.), platinum (melting point of 1768° C.), gold (melting point of 1064.2° C.), copper (melting point of 1083° C.), magnesium (melting point of 649° C.), tungsten (melting point of 3400° C.), molybdenum (melting point of 2610° C.), alloy of these metals, stainless steel (melting point 1400 to 1450° C. when SUS304 is used), cobalt-chromium or Inconel. (melting point of 1370 to 1425° C.), etc.

Moreover, as the powder material 35, there may be used a powder material obtained by mixing laser absorbent into the above-described metallic powder material. As the laser absorbent, there may be metal, pigment and dye, etc. which can absorb a laser beam having a specific wavelength used.

Further, as ceramic powder material, there may be used alumina (melting point of 2054° C.), silica (melting point of 1550° C.), zirconia (melting point of 2700° C.), magnesia (melting point of 2800° C.), boron nitride (BN; melting point, of 2700 to 3000° C.), silicon nitride (Si₃N₄; melting point of 1900° C.), and silicon carbide (SiC; melting point of 2600° C.), etc.

(iii) Constitution and Function of the Control Section

The control section 104 is constituted of a controller of the laser beam outputting section 102, and a controller of the thin layer forming section 103.

(Controller of the Laser Beam Outputting Section 102)

The controller of the laser beam outputting section 102 sends a control signal to the XYZ driver to perform a control as described below.

Namely, the controller of the laser beam outputting section 102 serves to change angles of the X-mirror 21a and the Y-mirror 21b to scan the laser beam on the basis of scanning lines which have been set with respect to forming regions of the base heating layer 35b, the preliminary heating layer 35c, and the solidified layer 35d, and to allow the laser beam source 23 to be turned ON or OFF appropriately. For such a time period, the controller of the laser beam outputting section 102 serves to continuously move the lens in accordance with motion of the laser beam so that the laser beam is focused on the surface of the thin layer of the powder material. In this way, the controller serves to selectively irradiate the laser beam to a specific region, of the thin layer of the powder-material to heat the specific region. Further, the controller serves to control an electric power applied to the laser beam source to thereby form a preliminary heating layer in which portions of respective powders are connected to each other. In addition, the controller serves to sinter or melt the thin layer of the powder material.

(Controller of the Thin Layer Forming Section 103)

The controller of the thin layer forming section 103 controls vertical movements of the part table 33a, and the first and second feed tables 34aa, 34ba, and the movement of the recoater 36, and controls heating process by means of heater or other heating means such as heating light source.

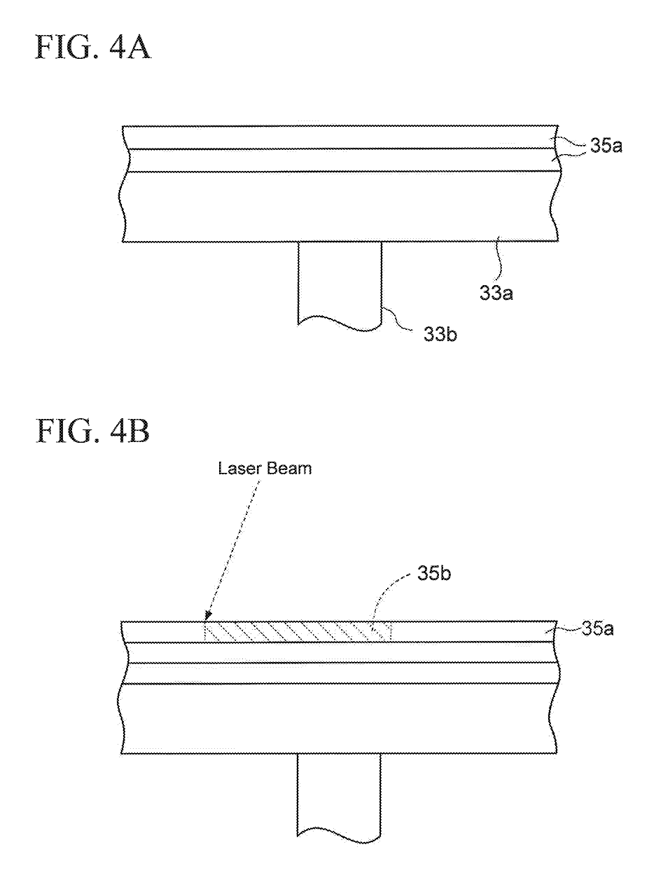

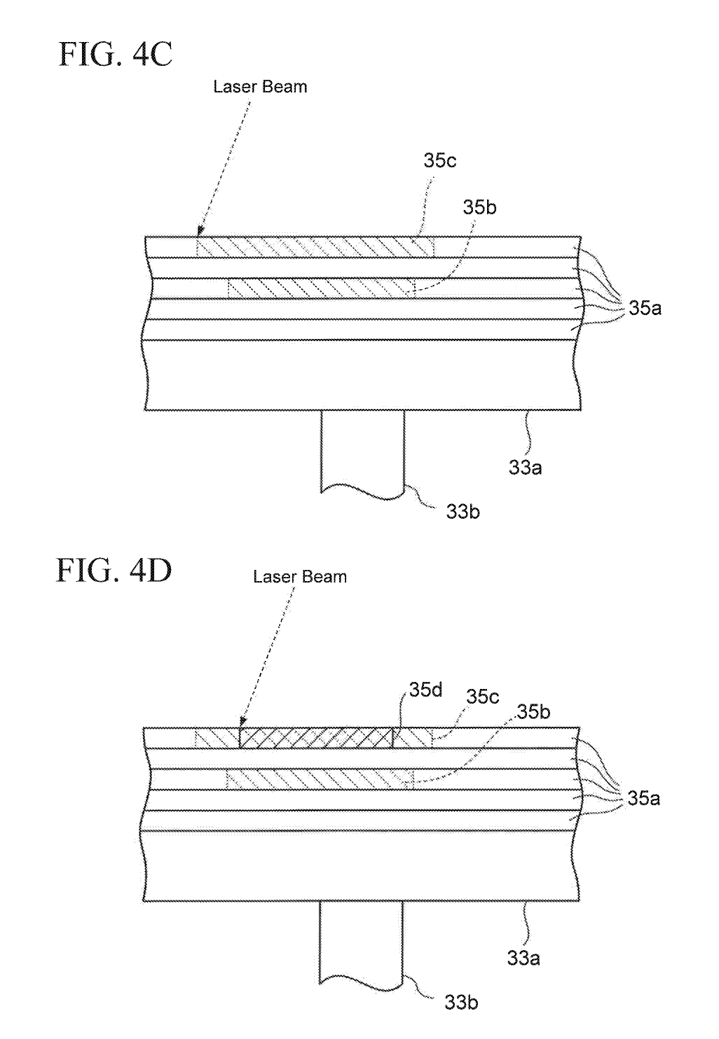

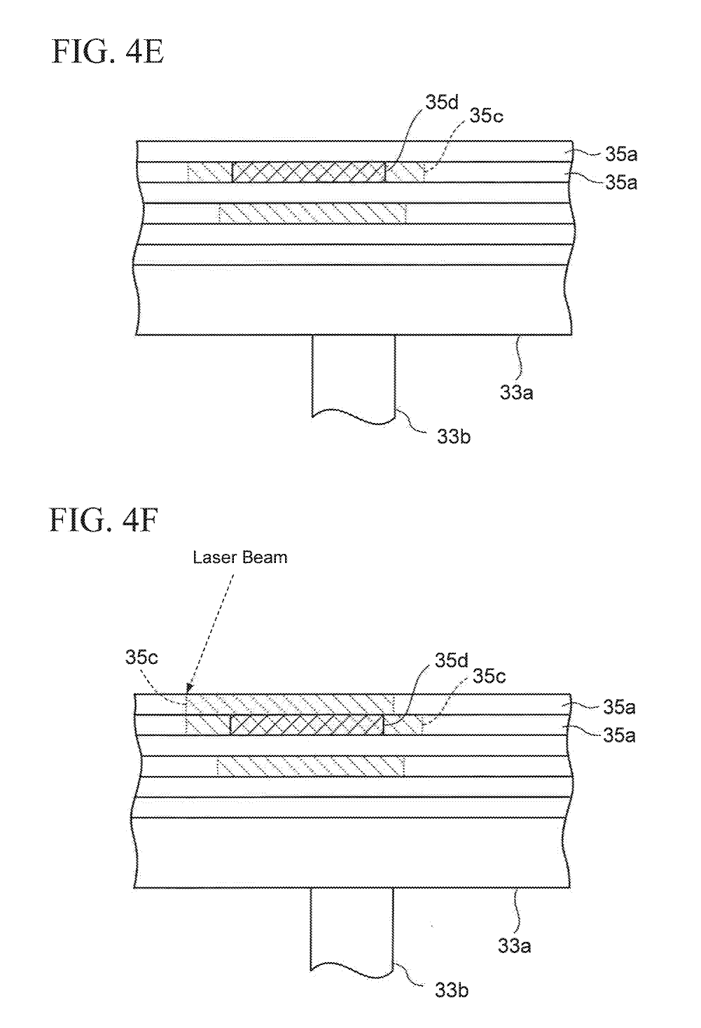

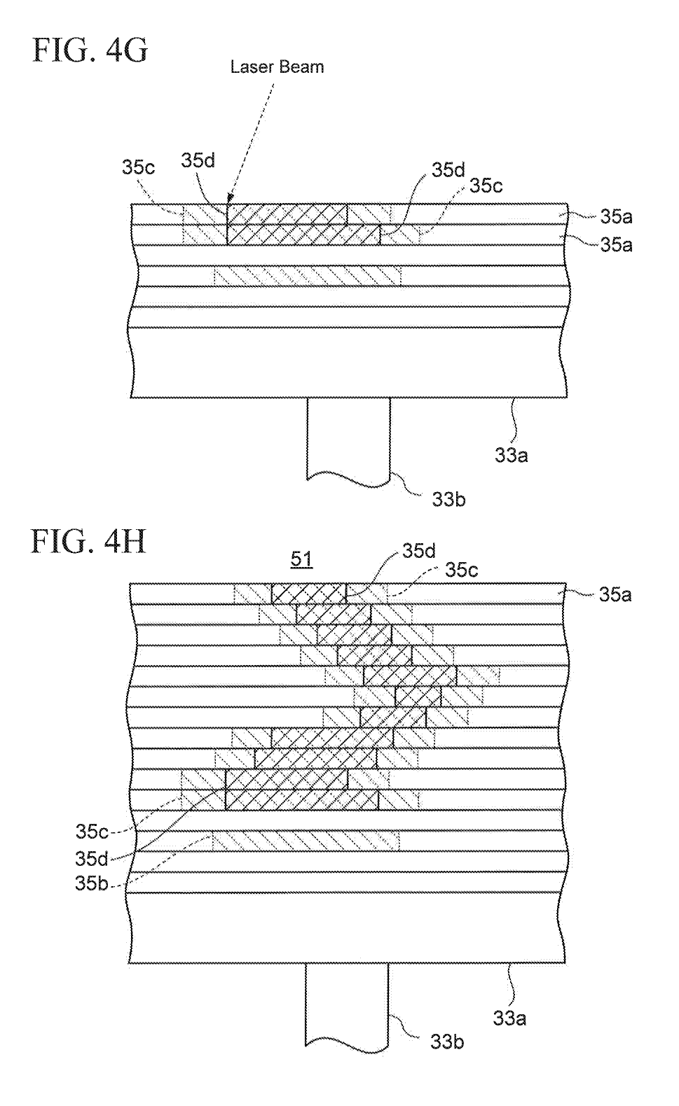

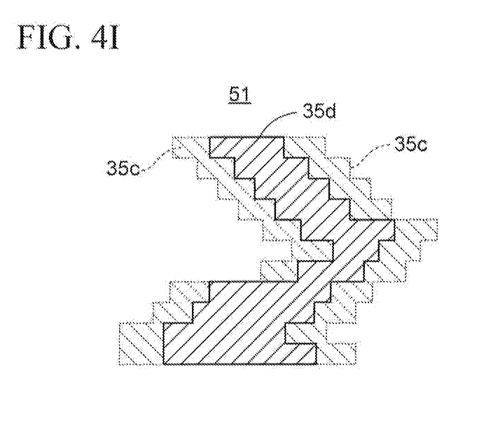

The control for implementing rapid prototyping process will be described with reference to FIGS. 3A to 4I. In this embodiment, as the powder material, there is used 64 titanium having a particle diameter of 45 μm or less and a mean particle diameter of about 30 μm. It should be noted that another powder material, whose diameter is changed at 53 μm or less, 150 μm or less, or the like, may be properly used in dependency upon an application.

The controller of the thin layer forming section 103 disposes the recoater 36 illustrated in FIG. 3B onto the upper surface peripheral edge part of the first powder material container 32a. Moreover, in order to remove water in the powder material, the controller controls the heating means such as heater, etc. for the respective containers 31, 32a and 32b so as to maintain the powder material at a saturated vapor pressure temperature or higher, or at vaporization temperature or higher during implementation of rapid prototyping process.

Next, the first feed table 34aa on which the powder material 35 is put is elevated, and the part table 33a is lowered by a single layer of the thin layer, e.g., approximately 60 μm which is a little larger than the maximum particle diameter of the powder material. It is necessary to change the thickness of a thin layer to be formed in accordance with various conditions described below. The various conditions are, for example, whether higher precision is required in the layer, whether the layer is made of a material easy to heat, and whether a temperature to be elevated is higher or lower, etc. Therefore, a lowering amount of the part table is determined in accordance with the conditions. Moreover, the second feed table 34ba is lowered to a degree such that powder material left after the thin layer 35a of the powder material 35 has been formed is sufficiently accommodated.

Next, the recoater 36 is moved toward the right side to scrape the powder material 35 projected on the first powder material container 32a and then carry the powder material 35 thus scraped to the thin layer forming container 31. Further, the powder material 35 thus carried is accommodated within the thin layer forming container 31 while smoothening the surface of the powder material to form the thin layer 35a to be the first layer onto the part table 33a (FIG. 4A). The powder material 35 left is carried up to the second powder material container 32b by further moving the recoater 36 toward the right side to accommodate the powder material thus carried onto the second feed table 34ba.

Next, the second feed table 34ba on which the powder material 35 is put is elevated, and the part table 33a is lowered by a single layer of the thin layer. Moreover, the first feed table 34aa is lowered to a degree such that the powder material 35 left after formation of the thin layer is sufficiently accommodated.

Next, the recoater 36 is moved toward the left side to scrape the powder material 35 projected on the second powder material container 32b and then carry the powder material 35 thus scraped into the thin layer forming container 31. Further, the powder material 35 is accommodated into the thin layer container 31 while smoothening the surface of the powder material to form a thin layer to be the second layer onto the thin layer 35a which has been formed as the first layer on the part table 33a (FIG. 4A). The powder material 35 left is carried up to the first powder material container 32a by further moving the recoater 36 toward the left side to accommodate the powder material on the first feed table 34aa.

Next, similarly to the first layer, a thin layer 35a of the powder material to be the third layer is formed on the thin layer 35a of the second layer (FIGS. 4A, 4B). The thickness of the thin layer 35a of the powder material of the third layer is caused to be slightly thicker, e.g., than the maximum particle diameter of the powder particle, i.e., about 60 μm.

Thereafter, as illustrated in FIG. 4B, the laser beam is selectively irradiated while controlling the movements of the mirrors 21a, 21b and the lens of the optical systems 21 and 22 by the controller of the laser beam outputting section 102 on the basis of slice data (drawing pattern) of the three-dimensional prototyping model. Thus, the thin layer 35a of the powder material which has been formed as the third layer is heated to form a base heating layer 35b whose temperature is elevated.

At this time, it is preferable that the temperature of the base heating layer 35b is caused to be a temperature lower than the melting temperature of the powder material. Further, it is preferable to be the temperature such that particle shape of the powder material is visible in the state where the powder material is not completely melted, while portions of respective powders are connected to each other to become a cluster of aggregate of the powder materials. Namely, it is preferable to hold the powder material, e.g., within a temperature range which is 300° C. or higher and lower than the melting temperature of the powder material and lower, by approximately 50° C., from the melting temperature.

In addition, it is desirable that the base heating layer 35b is caused, to have a larger area, by more than 5%, than a forming region of a solidified layer which is the lowermost layer of the three-dimensional prototyping model formed above the base heating layer 35b, and to have a shape without corner such as circle or waney square shape.

In this embodiment, the two thin layers 35a of the powder material which are not processed by any means are interposed below the base heating layer 35b on the elevating table. The two thin layers 35a serve as a buffer layer which prevents the base heating layer 35b from fixing directly onto the elevating table. In this case, instead of separately laminating the two thin layers of the powder material, the powder material having a thickness of equivalent two layers may be laminated at a time. Moreover, the thickness of the buffer layer may be changed as the occasion demands as long as no obstruction takes place.

Next, similarly to the second layer, the thin layer 35a of the powder material is formed as the fourth layer on the base heating layer 35b of the powder material.

Next, similarly to the first layer, a thin layer 35a of the powder material to be the fifth layer is formed on the thin layer 35a of the powder-material of the fourth layer (FIG. 4C). The thickness of the fifth layer is also caused to be, e.g., slightly larger than the maximum particle diameter of the powder particle, i.e., approximately 60 μm.

At this time, though a time is passed, a little from formation of the base heating layer 35b, the base heating layer 35b is maintained at a sufficiently high temperature. Because, in the base heating layer 35b, portions of the respective powders are connected to each other. Therefore, the calorific value of the thin layer becomes greater than that before the connection. This is the same also in a preliminary heating layer fabricated later. Accordingly, it is possible to elevate a temperature of a forming region of a solidified layer above the base heating layer 35b up to a temperature close to the melting point of the powder material and maintain that temperature.

Thereafter, the laser beam, is irradiated while controlling the movements of the mirrors 21a, 21b and the lens of the optical system by the controller 25 of the laser beam outputting section 102 based on slice data. Thereby, the thin layer 35a of the powder material of the fifth layer is selectively heated to form the preliminary heating layer 35c which is elevated at a temperature such that powder material results in a cluster of aggregate similarly to the base heating layer 35b (FIG. 4C). It is desirable that the preliminary heating layer 35c is set to include a peripheral region around a forming region of a solidified layer to be formed in the thin layer 35a of the powder material of the fifth layer, and to have a shape similar to the forming region of the solidified layer. It is desirable that an area of the peripheral region is set to 5% or greater of an area of the forming region of the solidified layer.

Next, heating energy beam is irradiated to an inside region of the preliminary heating layer 35c whose temperature has been elevated, thereby the inside region is melted and then solidified to form the solidified layer 35d (FIG. 4D). At this time, the single thin layer 35a of the powder material, which is not processed by any means is interposed between the base heating layer 35b and the solidified layer of the first layer. The single thin layer 35a serve as a buffer layer which prevents the solidified layer of the first layer from fixing to the base heating layer 35b. It is preferable that the thickness of the buffer layer is equivalent to a single layer or more of the thin layers of the powder material, particularly 5 to 10 layers thereof.

Next, similarly to the second layer, a thin layer 35a of the powder material to be the sixth layer is formed on the thin layer 35a of the powder material and the solidified layer 35d of the fifth layer (FIG. 4E).

Next, the laser beam is selectively irradiated to the thin layer 35a of the powder material of the sixth layer to form, a preliminary heating layer 35c whose temperature has been elevated up to a temperature such that powder materials result in a cluster of aggregate (FIG. 4F).

Next, the heating energy beam is irradiated to an inside region of the preliminary heating layer 35c whose temperature has been elevated, thereby the inside region is melted and then solidified to form a solidified layer 35d (FIG. 1G).

Thereafter, process steps of formation of the thin layer 35a of the powder material→formation of the preliminary heating layer 35c→formation of the solidified layer 35d→formation of the thin layer 35a of the powder material→formation of the preliminary heating layer 35c→formation of the solidified layer 35d→are repeatedly implemented to laminate a plurality of solidified layers 35d. Thus, a three-dimensional prototyping model 51 is fabricated. FIG. 4H illustrates the state after prototyping process of the three-dimensional prototyping model has been completed.

In accordance with the rapid prototyping apparatus according to the embodiment of the present invention which has been described above, the control section prototyping-controls to irradiate the heating energy beam to form the preliminary heating layer 35c, and then irradiate the heating energy beam to the thin layer of the powder material within the forming region of the preliminary heating layer 35c to melt and solidify the thin layer of the powder material thus to form the solidified layer 35d.

Namely, since the preliminary heating layer 35c is formed in the state of raising temperatures of the forming region of the solidified layer 35d and the peripheral region thereof before formation of the solidified layer 35d, a temperature difference between the forming region of the solidified laser 35d and the peripheral region is small when the solidified layer 35d is formed. Accordingly, it is possible to suppress warp of the solidified layer 35d. Further, in this case, the periphery of the solidified layer 35d is fixed to the preliminary heating layer 35c in which portions of respective powders are connected into a cluster form. Thus, it is possible to still more suppress the warp of the solidified layer 35d.

While it is possible to suppress the warp of the solidified layer 35d serving as a thin layer of the rapid prototyping model even if there is no base, heating layer 35b as described above, there is possibility that a temperature difference between the thin layer of the powder material and the peripheral region thereof may become large in forming the lowermost solidified layer of the rapid prototyping model. In this case, the base heating layer 35b may be formed below the forming region of the solidified layer 35d. Thereby, both the forming region of the lowermost solidified layer 35d and the peripheral region thereof are elevated up to a temperature close to the melting temperature of the powder material. For this reason, a temperature difference between the forming region of the lowermost solidified layer 35d and the peripheral region thereof becomes small in forming the lowermost solidified layer 35d, thereby it is possible to still more suppress the warp of the lowermost solidified layer 35d.

(2) Description of the Powder Rapid Prototyping Method

The powder rapid prototyping method using the above-described powder rapid prototyping apparatus will now be described.

First, oxygen, nitrogen and water are removed from, the powder material in a decompressed atmosphere before rapid prototyping process is started.

Next, in accordance with the above-described “control method for rapid prototyping”, rapid prototyping process is implemented. The detailed description of the rapid prototyping process is omitted. It is to be noted that the rapid prototyping process may be implemented in a decompressed atmosphere subsequently after oxygen, nitrogen and water are removed, or the rapid prototyping process nay be implemented in an atmosphere of inert gas after the decompressed atmosphere is replaced by inert gas such as argon, etc.

Since the three-dimensional prototyping model completed by the above-described “control method for rapid prototyping” is embedded in the powder material within the thin layer forming container 31, the prototyping model is taken out after the powder material is removed. In the rapid prototyping model 51 taken out, as illustrated in FIG. 4I, since the periphery of the solidified layer 35d is covered with a block of aggregate of the powder material (a portion of the preliminary heating layer) 35c, in which portions of respective powders of the powder material are connected to each other, the aggregate 35c of the powder material is finally removed to obtain three-dimensional prototyping model formed of the laminated solidified layers 35d. At this time, since the aggregate 35c of the powder material is merely in the state that portions of respective powders are connected to each other, it is possible to easily remove the aggregate 35c of the powder material from the solidified layer 35d without cutting, etc. of the aggregate 35c.

(3) First Modified Example

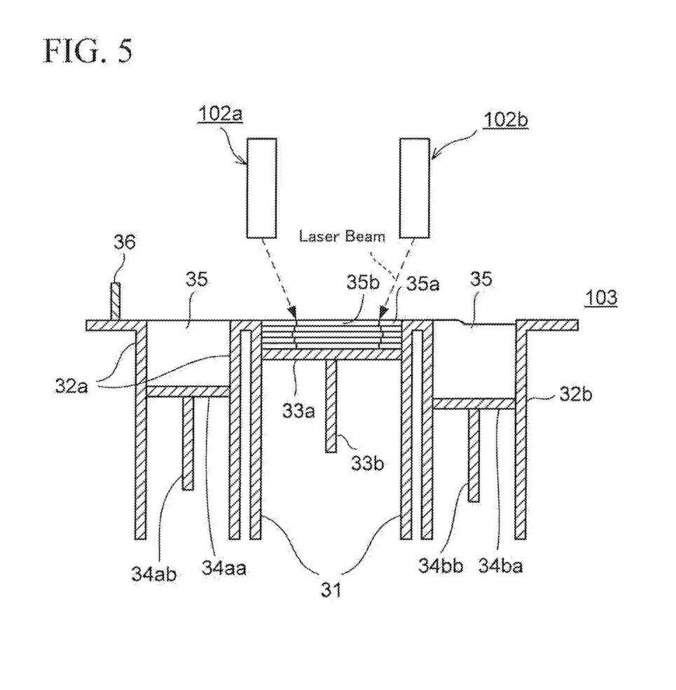

FIG. 5 is a diagram illustrating the constitution of a powder rapid prototyping apparatus according to the first modified example of the embodiment of the present invention.

The powder rapid prototyping apparatus according to the first modified example includes laser beam outputting sections 102a, 102b of the duplex system. Each of the laser beam outputting sections 102a, 102b includes the laser beam source 23, the optical system 21, the XYZ driver 24, and the controller 104.

Particularly, each of the laser beam sources of the duplex system includes a preliminary heating laser beam source and a solidification heating laser beam source. The preliminary heating layer 35c of the embodiment is formed by the preliminary heating laser beam source, and then continuously without time, the thin layer of the powder material is melted by the solidification heating laser beam source, and solidified, to form the solidified layer 35d.

These laser beam sources of the duplex system are both controlled by means of the controller 104 to thereby form the preliminary heating layer 35c and then form the solidified layer 35d within the preliminary heating layer 35c without time. Accordingly, it is possible to form the solidified layer 35d while the temperature of the preliminary heating layer 34c is uniform and is not lowered. Thus, it is possible to further more suppress the warp of the solidified layer 35d.

(4) Second Modified Example

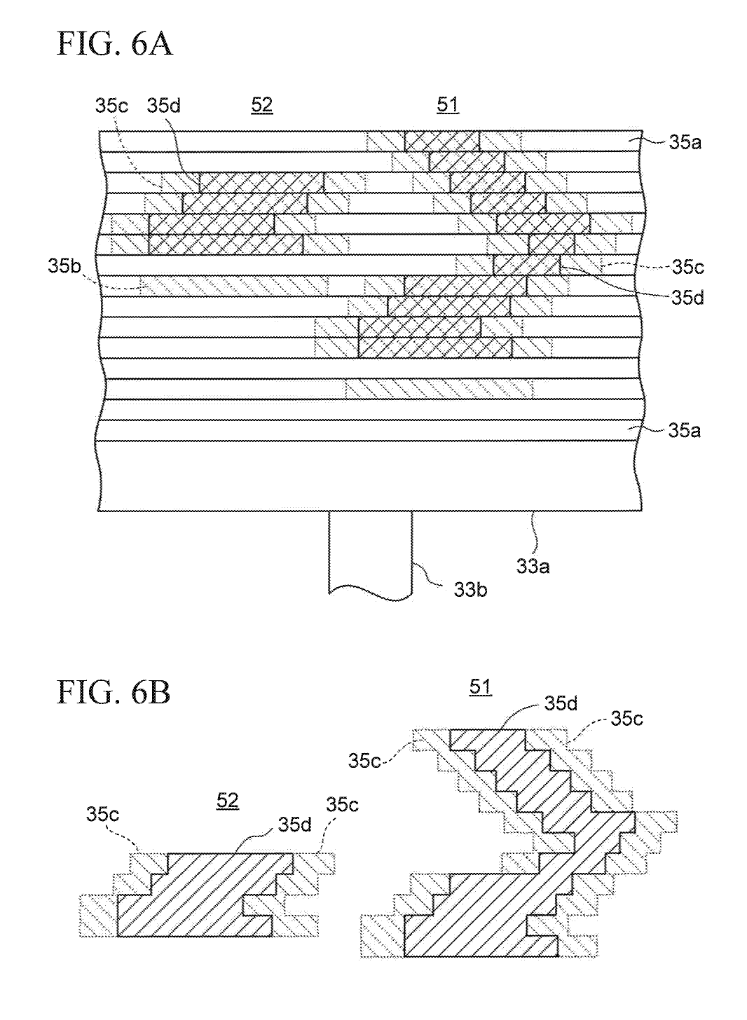

A rapid prototyping control method will now be described with reference to FIGS. 6A and 6B in connection with a controller of the thin layer forming section according to the second modified example, which is applicable to the powder rapid prototyping apparatus of FIGS. 3A and 3B.

While a single three-dimensional rapid prototyping model is fabricated on the part table 33a. in FIGS. 4A to 4I, another rapid prototyping model 52 is fabricated in the middle of lamination within an empty region around the forming region of the rapid prototyping model 51 in FIG. 6A. In this case, the rapid prototyping control will be performed as follows.

In FIG. 6A, the rapid prototyping process is implemented in accordance with FIGS. 4A to 4I until the process for the thin layer of the powder material of the seventh layer is completed.

Next, the part table 33a is lowered by a single layer of the thin layer and then a thin layer 35a of the powder material to be the eighth layer is formed on the thin layer 35a of the powder material of the seventh layer.

Next, the laser beam is irradiated to the thin layer 35a of the powder material of the eighth layer to selectively form a preliminary heating layer 35c of the rapid prototyping model 51. Subsequently, the laser beam is irradiated to the eighth layer while avoiding the forming region of the rapid prototyping model 51. Thereby, the thin layer 35a of the powder material of the eighth layer is selectively heated to thus form a base heating layer 35b. The base heating layer 35b is elevated at a temperature lower than the melting temperature of the powder material, and the temperature such that the powder material is not completely melted and thus particle shape of the powder material is visible while portions of respective powders are connected to each other to result in a cluster of aggregate of the powder materials.

Next, a solidified layer 35d is formed inside the preliminary heating layer 35c of the rapid prototyping model 51 in accordance with FIGS. 4A to 4I. The base heating layer 35b below the forming region of the prototyping model 52 is left as it is without being heated.

Next, a thin layer 35a of the powder material to be the ninth layer is formed. Then, a preliminary heating layer 35c of the rapid prototyping model 51 is formed in accordance with FIGS. 4A to 4I, and subsequently the solidified layer 35d is formed within the preliminary heating layer. In the forming region of the rapid prototyping model 52, the thin layer 35a of the powder material is left as it is without being heated.

Next, a thin layer 35a of the powder material to be the tenth layer is formed.

Next, the preliminary heating layer 35c or the rapid prototyping model 51 is formed in accordance with FIGS. 4A to 4I. Subsequently, the thin layer 35a of the powder material of the tenth layer is selectively heated within the forming region of the prototyping model 52 to thus form a preliminary heating layer 35c. The preliminary heating layer 35c is elevated at a temperature lower than the melting temperature of the powder material, and the temperature such that the powder material is not completely melted and thus particle shape of the powder material is visible while portions of respective powders are connected to each other to result in a cluster of aggregate of the powder materials.

Next, in accordance with FIGS. 4A to 4I, the solidified layer 35d is selectively formed within the preliminary heating layer 35c of the rapid prototyping model 51, and an inside region of the preliminary heating layer 35c of the rapid prototyping model 52 is heated to melt and then solidify, thus, the solidified layer 35d within the preliminary heating layer 35c is formed.

Thereafter, there are repeatedly implemented process steps of formation of a thin layer 35a of the powder material→formation of preliminary heating layers 35c within the forming regions of respective prototyping models 51, 52→formation of solidified layers 35d within the forming regions of the respective prototyping models 51, 52→formation of a thin layer 35a of the powder material→formation of preliminary heating layers 35c within the forming region of the respective prototyping models 51, 52→formation of the solidified layer 35d within the forming regions of the respective rapid prototyping models 51, 52 . . . to laminate a plurality of the solidified layers 35d. Thereby, two prototyping models 51, 52 are fabricated. FIG. 6A illustrates the state after prototyping process of two prototyping three-dimensional models has been completed. In addition, FIG. 6E illustrates the state when the two prototyping models 51, 52, which are embedded in the powder material within the thin film forming container 31, are taken out after prototyping process has been completed.

As described above, in this application, there is no need for mounting the base or the pins as in the above-described patent documents 1, 2 below the rapid prototyping model. Even in the middle of prototyping process, another rapid prototyping model can be fabricated while suppressing deformation, if there is any empty region.

(5) Third and Fourth Modified Examples

(i) Controller of a Thin Layer Forming Section of the Third Modified Example

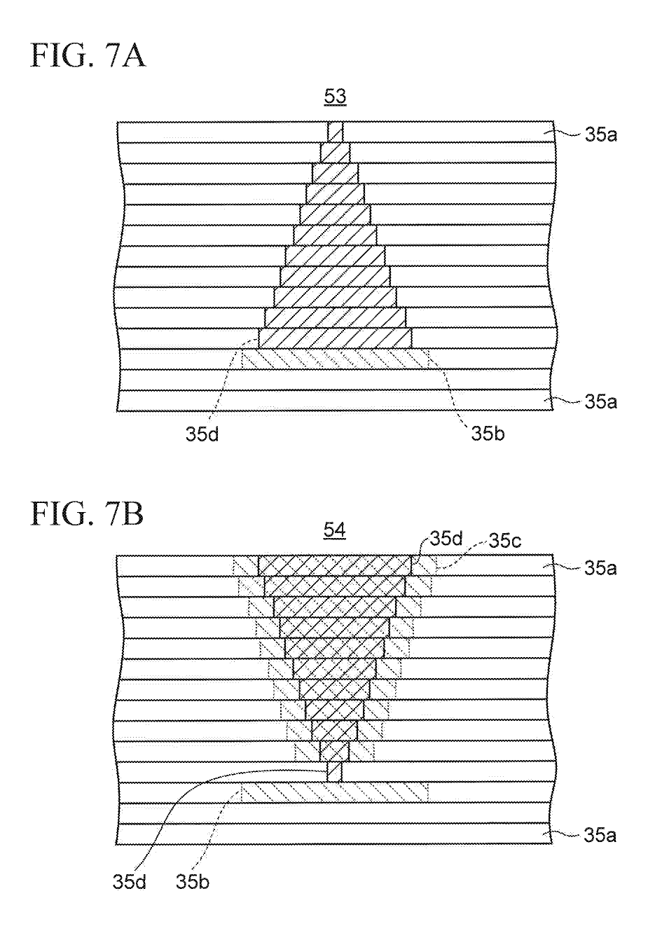

A rapid prototyping control method will now be described with reference to FIG. 7A in connection with the controller of the thin layer forming section of the third modified example applicable to the powder rapid prototyping apparatus of FIGS. 3A and 3B.

In the control method of the third modified example, which is different from the embodiment of FIGS. 4A to 4I, only the base heating layer 35b whose temperature has been elevated is formed, and no preliminary heating layer is formed before all solidified layers 53d are formed. Moreover, the lowermost solidified layer 35d of the three-dimensional prototyping model 53 is fixed to the base heating layer 35b.

This control method is effective in the case where a forming region of the solidified layer 35d becomes narrower with the upper layer of the three-dimensional prototyping model 53.

Namely, since a forming region of the lowermost solidified layer 35d of the three-dimensional prototyping model 53 exists within a region narrower than the base heating layer 35b provided below the forming region of the lowermost solidified layer 35d, a temperature difference between the forming region and a peripheral region thereof becomes small. Therefore, when a thin layer of the powder material is heated for the purpose of forming the lowermost solidified layer 35d, the thin layer of the entire forming region of the lowermost solidified layer 35d results in uniform temperature elevation and thus is uniformly melted. Thereafter, the thin layer of the entire forming region is uniformly cooled and thus solidified.

A forming region of the solidified layer 35d to be the second layer exists within a region narrower than the lowermost solidified layer 35d on the lowermost solidified layer 35d. Therefore, temperature of the forming region is elevated by the lowermost solidified layer 35d whose temperature has been elevated. Thus, a temperature difference between the forming region of the solidified layer 35d of the second layer and a peripheral region thereof becomes small. For this reason, when a thin layer of the powder material of the second layer is heated for the purpose of forming the solidified, layer 35d of the second layer, the thin layer of the entire forming region results in uniform temperature elevation and thus is uniformly melted. Thereafter, the thin layer of the entire forming region is uniformly cooled and thus solidified. This is the same also with respect to thin layers of the powder material to be the solidified layers 35d of the third layer or more.

According to the third modified example, it is possible to efficiently fabricate the prototyping model 53 while suppressing the deformation of the prototyping model 53.

(ii) Controller for a Thin Layer Forming Section of the Fourth Modified Example

A rapid prototyping control method will now be described with reference to FIG. 7B in connection with the controller for the thin layer forming section of the fourth modified example applicable to the powder rapid prototyping apparatus of FIGS. 3A, 3B.

The control method of the fourth modified example is the same as that of the embodiment of FIGS. 4A to 4I, regarding that the base heating layer 35b is formed and the preliminary heating layer 35c is formed before the solidified layer 35d is formed. On the other hand, the fourth modified example is different from the embodiment of FIGS. 4A to 4I, regarding that no preliminary heating layer is formed before the lowermost solidified layer 35d is formed, and that the lowermost solidified layer 35d of the three-dimensional prototyping model 54 is fixed to the base heating layer 35b.

Conversely to the third modified example, this control method is effective in the case where a forming region of the solidified layer 35d becomes broader with the upper layer of the three-dimensional prototyping model 54.

Namely, since the forming region of the lowermost solidified layer 35d of the three-dimensional prototyping model 54 exists within a region narrower than the base heating layer 35b, temperature of the forming region of the lowermost solidified layer 35d is elevated by the base heating layer 35b. Therefore, a temperature difference between the forming region and a peripheral region thereof becomes small. For this reason, when a thin layer of the powder material is heated for the purpose of forming the lowermost solidified layer 35d, the thin layer of the entire forming region results in uniform temperature elevation and thus is uniformly melted. Thereafter, the thin layer of the entire forming region is uniformly cooled and thus solidified.

On the other hand, a forming region of the solidified layer 35d to be the second layer exists within a region broader than the lowermost solidified layer 35d, but the preliminary heating layer 35c is formed within a region broader than the forming region of the solidified layer 35d before the solidified layer 35d of the second layer is formed.

Accordingly, in the forming region of the solidified layer 35d of the second layer, a temperature difference between the forming region and a peripheral region thereof becomes small. Therefore, when a thin layer of the powder material is heated for the purpose of forming the solidified layer 35d of the second layer, the thin layer of the entire forming region results in uniform temperature elevation and thus is uniformly melted. Thereafter, the thin layer of the entire forming region is uniformly cooled and thus solidified. This is the same also with respect to thin layers of the powder material serving as the solidified layers 35d of the third layer or more.

According to the forth modified example, it is possible to efficiently fabricate the prototyping model 54 while suppressing the deformation of the prototyping model 54.

While the present invention has been described in detail based on the preferred embodiments as described above, it should be noted that the scope of the present invention is not limited to the examples described in the embodiments, but changes or modifications of the embodiments within the scope which does not depart from the gist of the present invention are included within the scope of the present invention.

What is claimed is:

1. A powder rapid prototyping apparatus including:
an elevating table on which a thin layer of a powder material is formed;
heating energy beam outputting means which output a heating energy beam for heating the thin layer of the powder material; and
a control section which controls prototyping-process, wherein the control section
controls the elevating table to form a thin layer of the powder material on the elevating table,
controls the heating energy beam outputting means to irradiate the heating energy beam to a specific region of the thin layer of the powder material to thereby form a preliminary heating layer whose temperature is elevated, and
controls the heating energy beam outputting means to irradiate the heating energy beam, to an inside region of the preliminary heating layer whose temperature is elevated to melt and then solidify the thin layer to thereby form a solidified layer.

2. The powder rapid prototyping apparatus according to claim 1, wherein the control section controls the elevating table and the heating energy beam outputting means to form a base heating layer whose temperature is elevated below the preliminary heating layer before the forming of the preliminary heating layer.

3. The powder rapid prototyping apparatus according to claim 1, wherein the heating energy beam outputting means includes
preliminary heating energy beam outputting means, and
solidification heating energy beam outputting means.

4. The powder rapid prototyping apparatus according to claim 1 further including a decompression vessel in which the elevating table is installed to form the thin layer under a decompression environment.

5. The powder rapid prototyping apparatus according to claim 1, wherein the powder material is metal or ceramics.

6. A powder rapid prototyping method including steps of:
forming a thin layer of a powder material;
irradiating a heating energy beam to a specific region of the thin layer of the powder material to thereby form a preliminary heating layer whose temperature is elevated; and
irradiating the heating energy beam to an inside region of the preliminary heating layer whose temperature is elevated to melt and then solidify the thin layer to thereby form a solidified layer,
wherein the respective steps are repeatedly implemented to fabricate a rapid prototyping model.

7. The powder rapid prototyping method according to claim 6 further including a step of:
forming a base heating layer whose temperature is elevated by irradiating the heating energy beam below the preliminary heating layer before first forming the preliminary heating layer in the thin layer of the powder material.

8. The powder rapid prototyping method according to claim 6, wherein the steps are implemented under a decompression environment.

9. a rapid prototyping model in which a periphery of a solidified rapid prototyping model is covered by a portion of a preliminary heating layer.
